(19) United States
(12) Patent Application Publication
(10) Pub. No.: US 2008/0011905 A1
(43) Pub. Date: Jan. 17, 2008

(54) FLIGHT COMMAND AND DIRECTION ON GROUND COMMAND SYSTEM FOR AN AIRCRAFT

(75) Inventor: Bernard Guering, Montrabe (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/775,250

(22) Filed: Jul. 10, 2007

(30) Foreign Application Priority Data
Jul. 12, 2006 (FR) 0606339

(51) Int. Cl. B64C 25/50

(52) U.S. Cl. 244/228; 244/234

(57) ABSTRACT

Aircraft flight control and ground steering control system This electrical flight control system is intended for an aircraft that has a main landing gear with a front landing gear. It is provided with
a handle (2) that can move around two maneuvering axes (4, 6) by means of a linkage system (8), and is movable in rotation around a longitudinal axis substantially perpendicular to the maneuvering axes, means on each of the maneuvering axes for generating a pilot-operated instruction from a movement of the movable handle around one maneuvering axis, and
means for generating an instruction in order to act on the orientation of the front landing gear of the aircraft as a function of the angular position of the movable handle (2) relative to the longitudinal axis.

The present invention relates to an aircraft flight control and ground steering system.

In aircraft, especially for commercial passenger transportation, it is known to use electrical controls to pilot the aircraft in flight. For pitch and roll controls, it is likewise known to use a control device commonly known as the sidestick. This is generally integrated next to the pilot or copilot on a part of the instrument panel known as the side console.

Controls also exist for steering the aircraft when it is on the ground. These controls include in particular a control for orienting the front landing gear of the aircraft's main landing gear. In general, this control is also located on the side console of the instrument panel. To brake the aircraft on the ground, the pilot or copilot uses his feet to act on a control device known as the rudder pedal. This device is also used during flight to act on aerodynamic surfaces of the aircraft's rudder unit.

The technical problem underlying the invention is to simplify the flight deck of an aircraft by modifying the pilot-operated controls, in order to improve the ergonomics of this flight deck and to achieve cost, weight and volume savings.

To this end, it proposes an electrical aircraft flight control system that has a main landing gear with a front landing gear, comprising a handle that can move around two maneuvering axes by means of a linkage system, and means on each of the maneuvering axes for generating a pilot-operated instruction from a movement of the movable handle around one maneuvering axis.

According to the present invention, the movable handle is also movable in rotation around a longitudinal axis substantially perpendicular to the maneuvering axes, and means are provided to generate an instruction in order to act on the orientation of the front landing gear of the aircraft as a function of the angular position of the movable handle relative to the longitudinal axis.

In this way, when the aircraft is flying, the movable handle is used in the accustomed manner, or in other words as in a prior art aircraft, whereas when the aircraft is rolling on the ground the movable handle of the system, also known as the sidestick, is used to orient the front landing gear of the aircraft, thus making it possible to steer the aircraft.

In such an electrical flight control system, the means for generating an instruction may comprise, for example, a device for sensing the position of the movable handle relative to a reference position. In one embodiment, this position sensor may be a rotary potentiometer. This position sensor is preferably placed between the movable handle and the linkage system. In this way, the new function installed in the electrical flight control system has zero or very little impact on the structure of a known sidestick. This new function can therefore be implemented quite easily in a prior art flight control system.

To restore the movable handle automatically to a reference angular position when no action is being exerted on it, it can be provided that a double-spring system tends to return the movable handle to this reference angular position relative to its longitudinal axis.

Finally, the invention relates to an aircraft flight deck and to an aircraft, characterized in that they are equipped with a flight control system such as described above.

Details and advantages of the present invention will become clearer from the description provided hereinafter with reference to the attached schematic drawings, wherein:

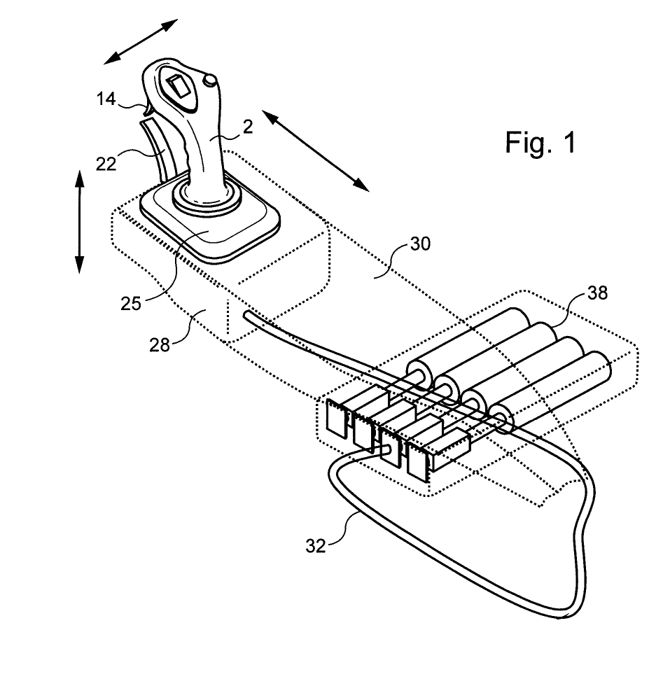

FIG. 1 represents an armrest equipped with a sidestick according to the invention,

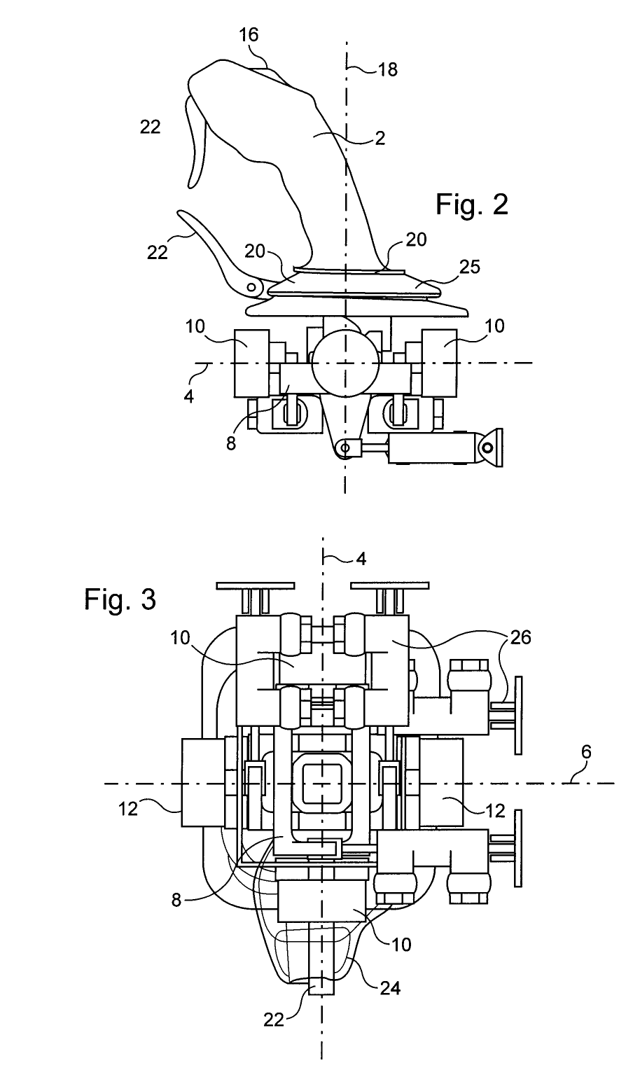

FIG. 2 shows the sidestick of FIG. 1 on a larger scale in side view,

FIG. 3 represents the sidestick of FIG. 2 viewed from below, and

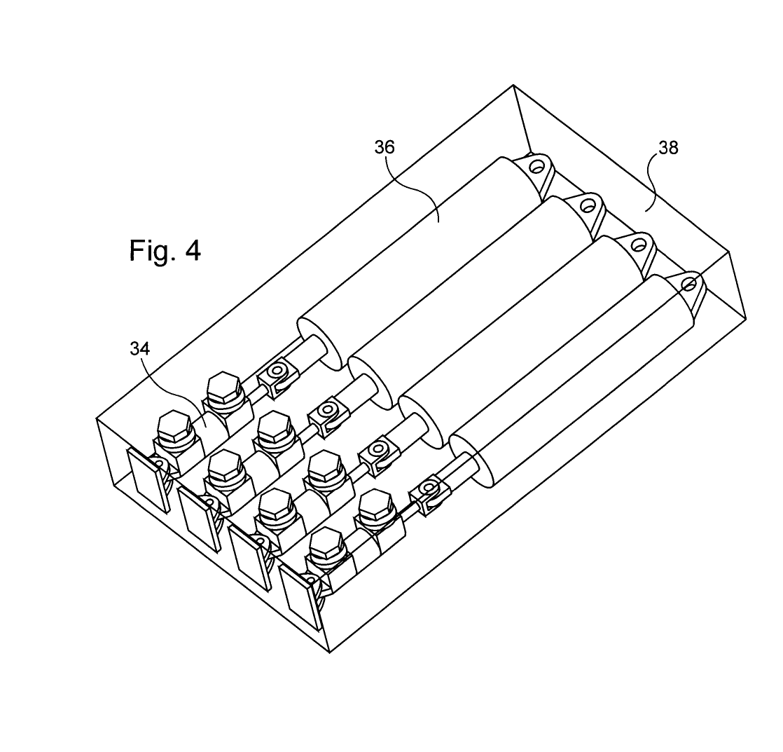

FIG. 4 shows a perspective view of a separately located power box of a sidestick according to the invention.

The sidestick illustrated in the drawings is provided in traditional manner with a movable handle 2 which, by means of a known mechanism, can pivot around a first roll-control axis 4 and around a second pitch-control axis 6. These two axes are perpendicular and disposed in the same substantially horizontal plane. A double universal joint linkage system 8 permits these two movements of the handle. This linkage system is not described in detail here, because it can be a linkage system similar to those used in prior art sidesticks. Such linkage systems are therefore fully known to those skilled in the art.

Also in known manner, the alternating movement of movable handle 2 around roll-control axis 4 is detected by two sensors 10, while two other sensors 12 detect the movements of movable handle 2 around pitch-control axis 6. The sensors are duplicated here for safety reasons. These sensors 10 and 12 generate pilot-operated electrical roll and pitch instructions that correspond to the alternating movements of movable handle 2 and that are destined for electric flight control calculators, not illustrated here, via electrical cables (not illustrated). Depending on the received signals, the calculators calculate the setpoint positions for the flaps, ailerons, etc. being controlled, and send these setpoints to actuators acting on these various aerodynamic devices.

In known manner, the movable handle is also equipped on the one hand with a send switch (push-to-talk switch) controlled by a lever 14 and on the other hand with a reset control button 16.

Compared with a movable handle of a prior art sidestick, movable handle 2 represented in the drawings has a third degree of freedom. In effect, the movable handle can pivot around an axis perpendicular to roll-control axis 4 and pitch-control axis 6. The movement of movable handle 2 around this third axis, or ground steering control axis 18, is detected by sensors 20. Just as for sensors 10 and 12, two sensors 20 are provided here for safety reasons. Each sensor 20 is a rotary potentiometer, for example. These sensors 20 are disposed at the base of movable handle 2, between it and double universal joint linkage system 8. Each sensor 20, in the embodiment illustrated in the drawings, has the form of a semi-torus, the two sensors 20 thus forming a toroidal ring at the base of movable handle 2.

When movable handle 2 is turned around ground steering control axis 18, it is restored to its neutral position by means of a double spring. One part of this double spring is compressed and the other part of this double spring is extended when movable handle 2 is out of its neutral position. The neutral position corresponds to the rest position of the two parts of this double spring.

As is evident in the drawings, movable handle 2 is equipped with a second lever, referred to hereinafter as brake lever 22. This is articulated around an axis parallel to pitch-control axis 6. A sensor 24 is illustrated only in FIG. 3. It is also a double sensor, which may be a linear or rotary potentiometer. Brake lever 22 and its associated sensor 24 are mounted on a base 25 of movable handle 2, brake lever 22 being placed in front of movable handle 2. Thus, when movable handle 2 turns around ground steering control axis 18, the brake lever also turns in such a way that brake lever 22 maintains the same relative position with respect to movable handle 2. A spring, not illustrated, is provided, for example, on the one hand to restore brake lever 22 to its rest position and on the other hand to simulate a braking force when a user acts on brake lever 22.

In known manner, artificial feel devices are provided on the roll-control and pitch-control axes in order to deliver a feel of exertion to the user. These feel devices are generally mechanical devices provided on the one hand with a spring and on the other hand with a shock absorber. Such prior art devices will not be further described here.

In original manner, the sidestick according to the invention is provided with hydraulic displacement transmission actuators 26. In the illustrated embodiment, four hydraulic actuators are provided. Each of these hydraulic actuators is disposed between double universal joint linkage system 8 and a box 28. This box contains in particular double universal joint linkage system 8 and the various sensors 10, 12 for pitch and roll controls, and it serves as support for movable handle 2. This box 28 is a rigid box housed in the front part of an armrest (FIG. 1).

Two hydraulic actuators 26 are provided on one side of roll-control axis 4 and two on one side of pitch-control axis 6. These hydraulic actuators 26 are disposed symmetrically in pairs relative to these control axes.

During rotation of movable handle 2 around roll-control axis 4 or around pitch-control axis 6, the volume of the chambers of hydraulic actuators 26 varies. Hydraulic fluid fills these chambers, and a hydraulic duct 32 containing a plurality of hydraulic conduits places each hydraulic actuator 26 in communication with a separately located hydraulic actuator 34. Each hydraulic actuator 34 is associated with a double-effect oleopneumatic actuator 36. The four hydraulic actuators 34 and the four double-effect oleopneumatic actuators 36 are disposed in a box designated as power box 38 illustrated in FIG. 4. This power box 38 is disposed as a function of its space requirement of the available space, preferably in the seat associated with armrest 30 supporting box 28 and movable handle 2. As an example, it may then be placed in the interior of or under the bottom of this seat, or else may be integrated in or attached to the back of this seat.

Double-effect oleopneumatic actuators 36 contain both a compressible fluid (gas) and an incompressible fluid (liquid). These double-effect oleopneumatic actuators 36 are therefore capable of functioning simultaneously as a spring and as a shock absorber. The spring and shock-absorber effect is then retransmitted by hydraulic actuators 34 and 26, which via hydraulic duct 32 are in communication with mobile handle 2 and therefore with the user (pilot) manipulating this movable handle.

By virtue of the separate location of artificial feel devices, the volume and weight associated with movable handle 2 of the sidestick can therefore be substantially reduced. This movable handle 2 then can be integrated into armrest 30 of a seat for an aircraft pilot. To permit adaptation to the morphology of the pilot, as indicated by the double arrows of FIG. 1, box 28 associated with movable handle 2 can be adjusted in three directions. These adjustments can be made by means of electric motors, and the adjustments can be stored in memory. A pilot can therefore easily adjust the position of movable handle 2 such that he can readily grasp it and store this position in memory, so that he does not have to repeat the same adjustment every time.

The fact that the sidestick is integrated in the seat for the pilot (and for the copilot) makes it possible to free up space in the side console of the aircraft. This makes the architecture of this instrument panel simpler and permits an overall simplification in the construction of the flight deck.

The fact that a third degree of freedom is provided in movable handle 2 makes it possible to add a new function to the sidestick. The function added here is the orientation of the wheels of the front landing gear of the corresponding aircraft. This function is ensured in prior art aircraft by an indicator light situated on the side console. The integration of this function in the sidestick therefore permits simplification of the instrument panel architecture in this case also. The pilot then uses the sidestick to steer his aircraft both when the aircraft is in flight and when it is on the ground.

Brake lever 22 is also used when the aircraft is in flight. In known prior art airplanes, the pilot uses the aircraft's rudder pedal to achieve braking of the wheels of the main landing gear. The brake lever proposed here makes it possible to achieve such braking.

The presence of this lever thus makes it possible to eliminate the rudder pedal. The rudder pedal is used in flight to act on the aerodynamic surfaces of the aircraft's rudder unit. The setpoints furnished to these aerodynamic surfaces by means of the rudder pedal can be obtained from calculators associated with the sidestick. In effect, these calculators are able, as a function of the position of the movable handle, to determine the setpoint values for acting on these aerodynamic surfaces. During flight, the rudder pedal controls are therefore replaced by roll and pitch controls communicated by the pilot via the movable handle, while on the ground the rudder pedal can be replaced by the brake lever integrated in the sidestick.

The integration of the brake lever in the sidestick therefore makes it possible to eliminate the rudder pedal generally found on an aircraft flight deck. In this way an additional simplification of the aircraft flight deck is therefore achieved.

It is possible to provide brake lever 22 with an artificial feel device. This can be merely a spring, although it is also conceivable to have a hydraulic control associated with the brake lever. Thus, it would be possible to associate a hydraulic actuator with the brake lever and to provide a hydraulic actuator and a supplementary single-effect or double-effect oleopneumatic actuator in power box 38.

The present invention is not limited to the preferred embodiment described above by way of non-limitative example and to the suggested alternative embodiments. It also relates to all variants conceivable by the person skilled in the art within the scope of the claims below.

Thus the double-effect oleopneumatic actuators described above could be replaced by other devices making it possible to create, in the movable handle, a feel similar to that obtained with springs and shock absorbers. For example, it would be possible to provide pilot-operated active hydraulic actuators or else electrical servo controls, with which the laws of action and reaction could be simulated.

1. An electrical aircraft flight control system that has a main landing gear with a front landing gear, comprising a handle (2) that can move around two maneuvering axes (4, 6) by means of a linkage system (8), and means on each of the maneuvering axes for generating a pilot-operated instruction from a movement of the movable handle around one maneuvering axis,
characterized in that the movable handle is also movable in rotation around a longitudinal axis substantially perpendicular to the maneuvering axes, and in that means are provided to generate an instruction in order to act on the orientation of the front landing gear of the aircraft as a function of the angular position of the movable handle (2) relative to the longitudinal axis.

2. An electrical flight control system according to claim 1, characterized in that the means for generating an instruction comprise at least one device (20) for sensing the position of the movable handle (2) relative to a reference position.

3. An electrical flight control system according to claim 2, characterized in that the position sensor (20) is a rotary potentiometer.

4. An electrical flight control system according to one of claims 2 or 3, characterized in that the position sensor (20) is placed between the movable handle (2) and the linkage system (8).

5. An electrical flight control system according to one of claims 1 to 4, characterized in that a double-spring system tends to return the movable handle (2) to a reference angular position relative to its longitudinal axis.

6. An aircraft flight deck, characterized in that it is equipped with a flight control system according to one of claims 1 to 5.

7. An aircraft, characterized in that it is equipped with a flight control system according to one of claims 1 to 5.
